(19) United States
(12) Patent Application Publication
(10) Pub. No.: US 2007/0038451 A1
(43) Pub. Date: Feb. 15, 2007

(54) Voice recognition for large dynamic vocabularies

(76) Inventors: Laurent Cogne, Boistrudan (FR); Serge Le Huitouze, Erce-Pres-Liffre (FR); Frederic Soufflet, Saint-Aubin-Du-Pavail (FR)

Correspondence Address: BLANK ROME LLP, 600 NEW HAMPSHIRE AVENUE, N.W., WASHINGTON, DC, 20037, US

(21) Appl. No.: 10/563,624

(22) PCT Filed: Jul. 8, 2004
(86) PCT No.: PCT/FR04/01799

§ 371 Date: May 19, 2006

(30) Foreign Application Priority Data
Jul. 8, 2003 (FR) 03/08341

(51) Int. Cl. G10L 15/14

(52) U.S. Cl. 704/256; 704/10

(57) ABSTRACT

A voice recognition method includes: representing a vocabulary translated into a Markov network; decoding by means of a Viterbi algorithm; and pruning explored solutions. The vocabulary is described in a tree made up of arcs and of nodes, between which transcriptions are defined that describe phonetic units used by a language model. The Markov network is constructed dynamically at least in part by means of Markov sub-units.

The present invention relates to the field of voice recognition.

The present invention relates more particularly to the field of voice interfaces. It offers the advantage of being usable independently of the context of the particular voice application, be it an application to a speech recognition system for a telephone server, an application to voice dictation, an application to an on-board monitoring and control system, or an application to indexing recordings, etc.

Currently available speech recognition software is based on use of Hidden Markov Models (HMMs) to describe the vocabulary to be recognized, and on decoding using an algorithm of the Viterbi type for associating a phrase of said vocabulary with each utterance.

The Markov networks in question usually use states having continuous density.

The vocabulary of the application, be it originally based on grammars or on stochastic language models, is compiled into a network of finite states, with a phoneme of the language used at each transition of the network. Replacing each of the phonemes with an elementary Markov network that represents said phoneme in its coarticulation context finally produces a large Markov network to which the Viterbi decoding can be applied. The elementary networks themselves have been learnt by means of a training corpus and with a training algorithm that is now well-known, e.g. of the Baum-Welch type.

Such methods, which are now conventional, are described, for example, in the reference work by Rabiner, and the use of language models is described in the reference work by F. Jelinek.

However, in order to give a description that is complete herein, the various components of a present-day voice recognition engine are described below in simplified manner and in a particular example of a use.

Conceptually, a speech signal is a string of phonemes that is continuous or that is interrupted with pauses, silences, or noises. The acoustic properties of the speech signal can, at least for the vowels, be considered to be stable over times of about 30 milliseconds (ms). A signal coming from the telephone, and sampled at 8 kHz is thus segmented into frames of 256 samples (32 ms) with an overlap of 50% so as to guarantee a certain amount of continuity. The phonetic information is then extracted from each of the Lrames by computation, e.g. in this implementation example, of the first 8 Mel Frequency Cepstral Coefficients (MFCCs) (see [Richard]), of the energy of the frame, and of the first and second derivatives of those 9 magnitudes. Each frame is then represented, also in this particular example, by a 27-dimension vector referred to as an “acoustic vector”. Because of inter-speaker and intra-speaker variations, recording condition variations, etc. in the speech signals, a phoneme is not represented by a point in that space, but rather by a cloud of points, around a certain mean with a certain spread. The distribution of each cloud defines the density of probability of appearance of the associated phoneme. Although such MFCC extraction is judicious, it is necessary to obtain, in that space, a set of classes that are relatively compact and that are separated from one another, each corresponding to one phoneme.

After that acoustic extraction phase, the speech signal is thus described by a string of acoustic vectors, and the recognition work consists in determining which string of phonemes is, most probably, associated with that string of acoustic vectors.

Thus, conceptually, a speech signal is a string of phonemes that is continuous or interrupted by silences, pauses, or noise. The word “zéro” (“zero”), for example, is constituted by the phonemes [z], [e], [r], [o]. It is possible to imagine a left-to-right Markov network having 4 states, each state being associated with a respective one of those phonemes, and in which no jumping over a state is permitted. With a trained model, it is possible, by means of the Viterbi algorithm to “align” a new recording, i.e. to determine the phoneme associated with each of the frames. However, because of the coarticulation phenomena between phonemes (modification of the acoustic characteristics of one phoneme when the vocal tract changes shape between two stable sounds), it is necessary to associate a plurality of states with the same phoneme, in order to take account of the influence of the context. It is thus possible to obtain input contextual states, “target” states, and output contextual states. Such target states correspond to the stable portion of the phoneme, but they can themselves depend on coarticulation phenomena, so that there are, in general, a plurality of targets. In this particular example, it is thus possible, for example, to use elementary Markov networks that are butterfly-shaped so as to model the elementary phonemes of the language.

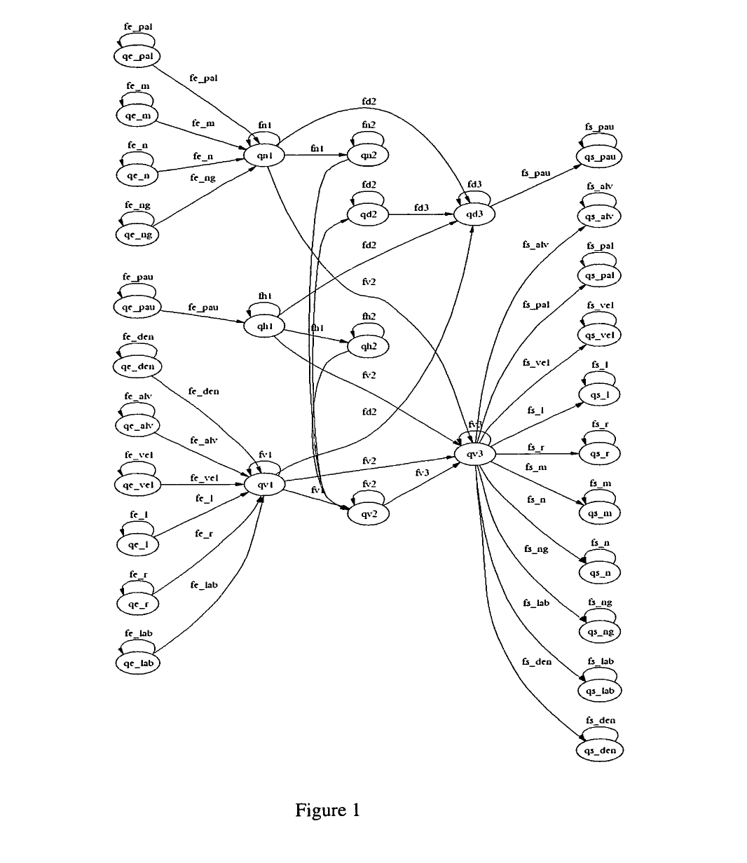

With the preceding example, for the phoneme [e], a network would, for example, be obtained as shown in FIG. 1.

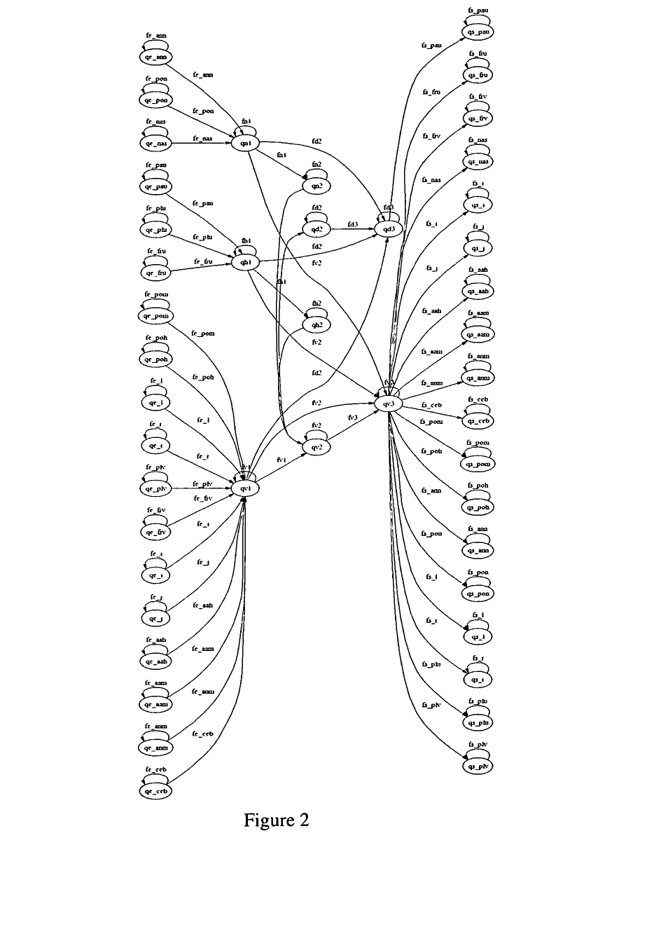

For example, for the phoneme [z], a network would be obtained as shown in FIG. 2.

Similarly, each of the phonemes used to describe the language in question is associated with this type of Markov network, which differs in shape but which always presents contextual inputs and outputs that are dependant on coarticulation phenomena.

The various networks, each of which corresponds to a phoneme of the language, have probability densities and transition probabilities that are determined by training on a corpus of recorded phrases, with an algorithm of the Baum-Welch type being used to obtain the various parameters (see Rabiner, for example).

The vocabulary to be recognized varies as a function of the application: it can be a name, or a telephone number, or more complicated request, e.g. whole phrases for a dictation application. It is thus necessary to specify the words to be recognized, their concatenation, or their concatenation probability, and the syntax of the phrases if it can be known and described, so as to use that additional knowledge, so as to simplify the Markov networks, and so as to obtain good performance in terms of computation time and of recognition rate.

It is the role of the language model to represent that knowledge.

In the example given by way of illustration of the state of the art in this field, language models are used that are based on probabilistic grammars rather than on stochastic language models, such as, for example, those used in dictation systems.

A very simple grammar is constituted by the article-noun-verb syntax, with “le” (“the”) as the article, “chien” (“dog”) as the noun, and “mange” (“eats”) or “dort” (“sleeps”) as the verb. The compiler transforms the grammar into a Markov network, by putting the butterflies of the various phonemes end-to-end, by eliminating the non-useful (unnecessary) branches, for all of the phrases compatible with the syntax. The initial state is set by a specific butterfly representing the silence at the beginning of a phrase. It is connected to the “pause” input of the butterfly of the phoneme /1/. Only those branches which are accessible by transition from that input are kept, until the output corresponding to the phoneme /ø/. That output is then connected to the input of the butterfly of /ø/ corresponding to /1/. Then, by transition, only those branches which are useful (necessary) in the butterfly are kept, and the process continues until the possibilities of the grammar are exhausted. The network necessarily ends on a butterfly modeling the silence at the end of the phrase. Branches of the network can be parallel, if there are a plurality of possibilities of words like “mange” (“eats”) or “dort” (“sleeps”), if it is desired to insert an optional pause between two words, or if a plurality of phonetizations are possible for the same word (e.g. “le” (“the”) can be pronounced [lø] or [lœ] depending on the region of origin of the speaker).

In addition, at the end of each sub-network (a sub-network corresponding, for example, to a word), an “empty” transition is inserted, i.e. a transition with a transition probability equal to 1, attached to a “label” which is a string of characters giving the word represented by said sub-network (it is used during the recognition).

The result of the compilation is a complex network (the more complicated the grammar, the more complex the network), optimized for recognizing a certain type of utterance.

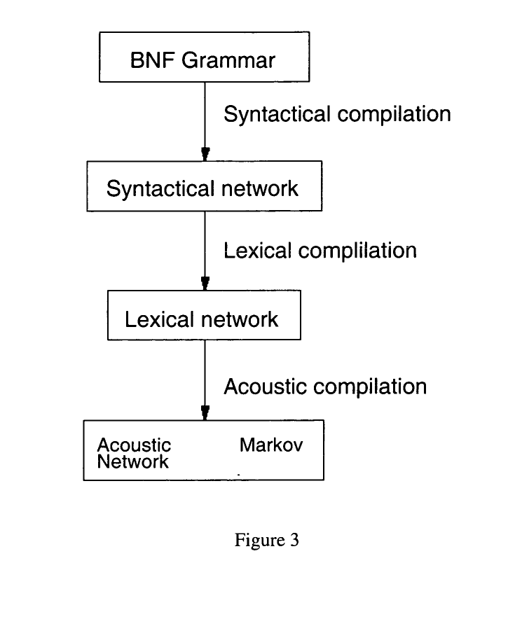

The construction of the Markov network of an application is referred to as “compilation” and it thus comprises three phases, shown in FIG. 3.

In order to illustrate these phases, another simple example is used, based on a grammar using the World Wide Web Consortium Augmented Backus-Naur Format (W3C ABNF):

#ABNF 1.0 ISO-8859-1;

language fr;

root $main;

public $main = $BEGSIL (tête | jambe) $ENDSIL;

This grammar makes it possible merely to describe the language model that makes it possible to recognize the word “tête” (“head”) or the word “jambe” (“leg”) in isolated manner, i.e. preceded and followed by silences (and not to find occurrences of those words in more complex phrases).

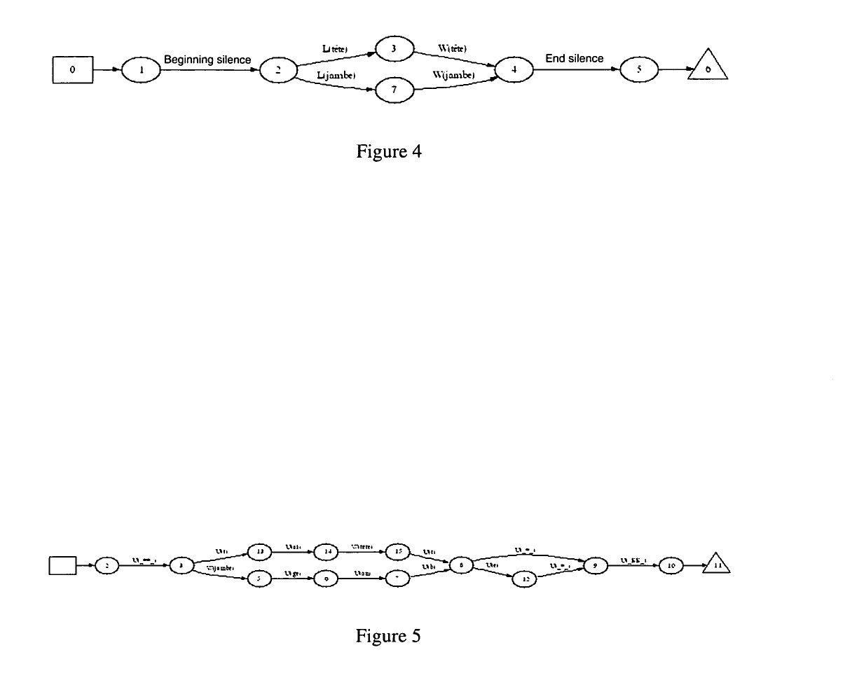

When that grammar is compiled at syntactical level, the network shown in FIG. 4 is obtained.

The transitions marked W are word markers that serve, after decoding, only to find the word actually uttered. The transitions marked L indicate an actual word of the language that is to be phonetized.

Then lexical compilation, which expresses the phonetization of the words and the insertion of the resulting phonetics into the network, produces the network shown in FIG. 5.

In this graph, as in the others, the numbers of the states are of no importance. The word markers can be observed once again, and they are situated arbitrarily in the network so that they are indeed present over the entire path of the graph that represents the associated word, and not on the others.

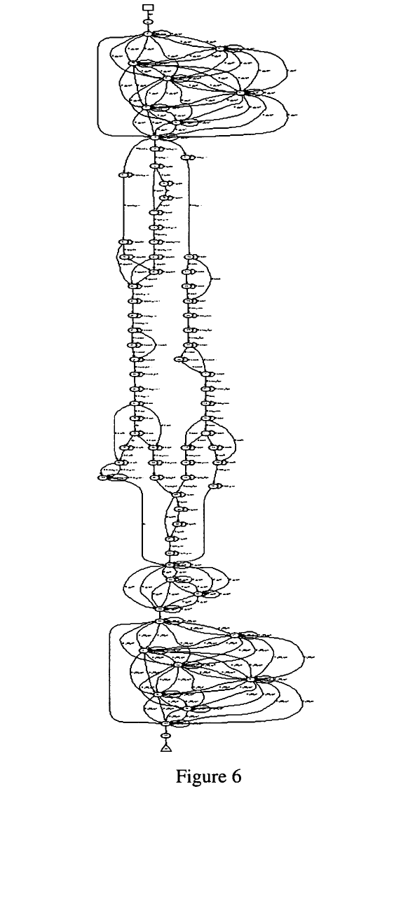

Finally, acoustic compilation makes it possible to obtain the final Markov network, by using acoustic modes instead of the associated phonemes, by applying the contextual connection conditions of the models, and by optimizing the network. That Markov network is shown in FIG. 6.

In the graph of FIG. 6, the word markers are still present, and even duplicated sometimes.

The diagram of FIG. 6 is shown merely to show that its complexity and the number of states that it has are much larger than for the lexical level. Acoustic compilation is by far the longest phase, producing the largest network.

Once the Markov network of the application has been built as described above, it is then used by the recognition engine for understanding (decoding) the phrases uttered by the user.

In a first stage, as described above, the speech signal is converted by means of the acoustic extraction phase into a string of acoustic vectors.

It is then a question of determining which path through the Markov network of the application is most probably associated with said string of acoustic vectors, or else of deciding that the utterance is not one of the phrases that the application is built to recognize.

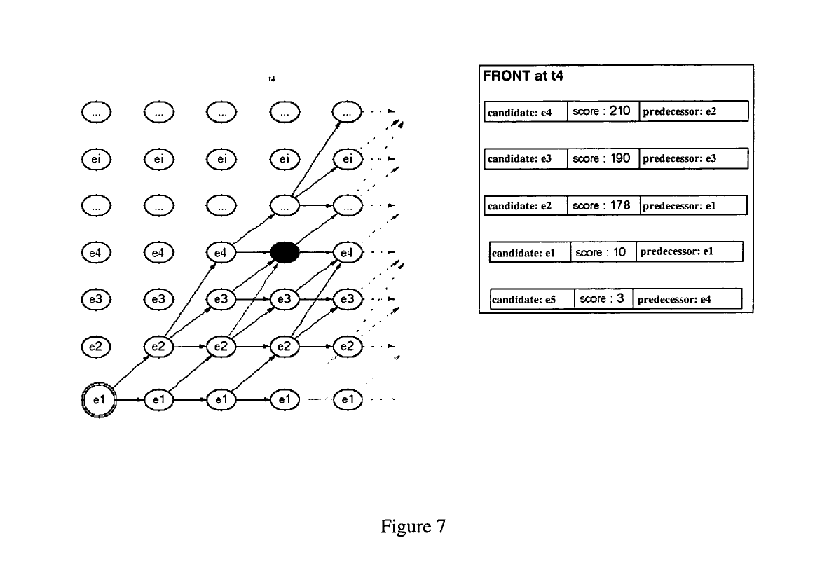

This is achieved by using the Viterbi decoding algorithm, for example. The principle of the decoding is shown in FIG. 7.

The various acoustic vectors that reach the recognition engine regularly (e.g. every 16 ms in this example) are plotted in discrete time along the x-axis of the diagram.

The various states of the Markov network of the application, as obtained after the above-described compilation phase, and that use both the butterfly structure of the elementary phonemes of the language and also the grammar of the application are plotted up the x-axis.

Thus, although all of the states of the network are represented on the vertical axis, only certain transitions between those states are possible, with a certain probability, and, at the beginning, we are necessarily in one of the states associated with the beginning silence, represented as a double circle in FIG. 7.

Considering all of the permitted transitions, the score of the best path leading to any state Ej is then computed at each new frame.

Then pruning is preformed, i.e. only the n best candidates are kept for the developments associated with the next frames, or in certain variants of the algorithm, only those states which are have scores sufficiently close to the score of the best path (i.e. the path that, at time Ti, obtains the highest score) are kept.

By way of example, the diagram shows the front at instant t4, with the scores of the various candidates. If, for example, it was chosen to limit the front to 3 states, then the development hypotheses for the front that are shown in green, would not have been explored.

In the same way, if it was decided to keep only those candidates which have a score at least equal to 10% of the maximum score, then the same hypotheses would not have been explored.

In reality, several hundreds or even several thousands of candidates are generally kept, depending on the complexity of the grammar.

It should be noted that, if the grammar is complex, it can happen frequently that only a small portion of the Markov network is actually used in the decoding, the remainder not being visited because of the pruning itself, which removes the very low probability hypotheses.

When all of the speech frames have been used up, the path obtained as being the most probable path is the path which has the highest score obtained by the algorithm and for which the output state of the network is reached. Backtracking is then performed through the string of associated states, from the last to the first, in order to obtain the phrase that was probably spoken, by using the fronts kept at the various instants.

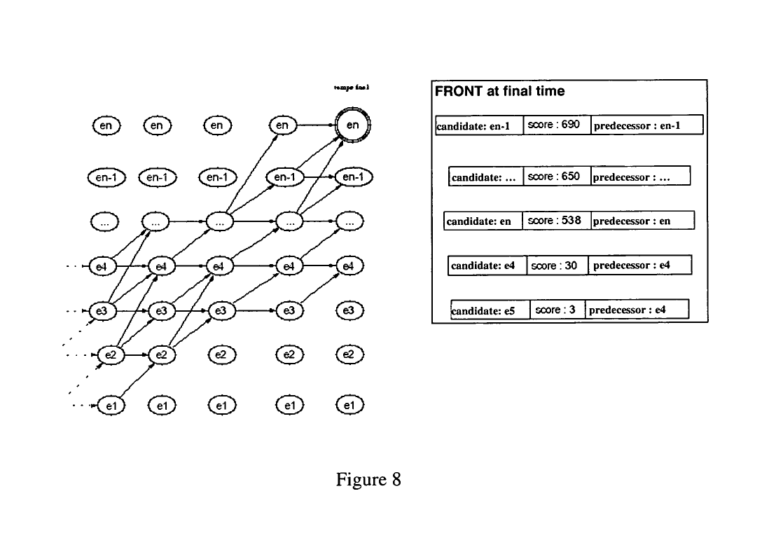

This is shown in FIG. 8.

Rather than keeping only the string of states that has obtained the best score, it is possible to keep a plurality of strings of state, while being careful to take into consideration only those strings which are actually associated with the various different utterances (and not with variants of the same utterance, with, for example, different temporal alignments or indeed with different pronunciation variants).

This technique, referred to as “Nbest decoding”, can be used to obtain the n best candidates, with an associated score for each candidate, the higher the probability of the phrase, the higher the score.

In the event that a plurality of transitions lead to a single node, then, unlike with Viterbi decoding, Nbest decoding makes it necessary to keep not only the predecessor that produces said best score, but a plurality of predecessors, and their associated scores.

Thus, for example, if it transpires that the final network is in fact a tree, i.e. if a node can have a plurality of successors, but if a node still has only one predecessor, then the phrase actually spoken can be simply deduced from the last node reached, and it is then possible to perform the Nbest decoding without any extra cost, merely by classifying the final nodes in decreasing order of score.

The state-of-the art voice recognition that is described above uses a hidden Markov network that is constructed by compilation in three phases: syntactical compilation, lexical compilation, and then acoustic compilation, the latter phase being by far the longest and producing the largest network.

The network obtained is used by a Viterbi decoding algorithm with pruning, i.e. only those solutions which seem to be the most promising are developed, the others being abandoned.

By means of the pruning principle, each recognition uses a different sub-portion of the network.

As described above, for decoding, prior art recognition engines use a compiled network that represents the active vocabulary, and more exactly all of the phrases that the application can recognize. Such compilation is often a slow process, even on powerful machines, and the resulting compiled network can take up quite a large amount of memory.

That is a problem above all for vocabularies that are large, such as lists of names used in voice assistance for directories (several hundreds of thousands of names, or even several millions for certain large cities), and, in addition, that are dynamic: it is necessary to be able to construct rapidly the list associated with a geographical zone in a request for broadening the search around a given city, for example.

As explained above in the presentation of the state of the art, present-day voice recognition is based on a Markov network that is built in successive stages, the last stage, which is the most time-consuming, finally producing a network that is usable directly in the decoding algorithm.

The decoding itself is based on the Viterbi algorithm with pruning, i.e. only the highest-scoring hypotheses are kept in the temporal development of the search for the best candidates.

When the vocabulary of an application is large, or when the grammars are complex, and therefore when the Markov network of the application has a very large number of states, it results from the pruning that only a small portion of the network is actually used during any given decoding, the remainder representing portions of the vocabulary or of the grammar that are phonetically very different from what is actually uttered.

The principle of the invention is, for each decoding operation, to build dynamically the small portion of the useful network rather than, as in the prior art, building firstly the whole network which is then used as it is in all of the subsequent decoding operations.

More precisely, the principle of the invention is to build a phonetic tree representing the vocabulary of the application. This diagram corresponds, as it were, to the result of the of the first compilation stages, up until the lexical phase.

The diagram is extremely quick to produce, even for very large vocabularies having several hundreds of thousands of words.

The diagram is then used during each decoding operation so as to make it possible to build that portion of the acoustic Markov network which is necessary depending on the pruning that is present.

To this end, the present invention, in its most general acceptation, provides a voice recognition method comprising a step of representing a vocabulary translated into a Markov network, a step of decoding by means of a Viterbi algorithm, and a step of pruning the explored solutions; said voice recognition method being characterized in that said vocabulary is described in the form of a tree made up of arcs and of nodes between which transcriptions are defined that describe the phonetic units used by the language model of the application, and in that the Markov network necessary for the Viterbi decoding is constructed dynamically at least in part by means of Markov sub-units.

Advantageously, the words of the vocabulary that are different but that present identical phonetic segments at the beginning of the word share, for the identical segments, the same branches of the phonetic tree.

In an embodiment, said phonetic units are phonemes.

In another embodiment, said phonetic units are context phonemes.

The present invention also relates to a voice recognition system for implementing the voice recognition method, said voice recognition system comprising at least one memory and computation means.

The invention will be better understood on reading the following description of an implementation of the invention given merely by way of explanation and with reference to the accompanying figures, in which:

FIG. 1 shows an example of a Markov network corresponding to a phoneme;

FIG. 2 shows another example of a Markov network corresponding to a phoneme;

FIG. 3 shows construction or “compilation” of the Markov network of an application;

FIG. 4 shows a network obtained when a grammar is compiled at syntactical level;

FIG. 5 shows a network produced by lexical compilation, which expresses phonetization of the words and insertion of the resulting phonetics into the network;

FIG. 6 shows another example of a Markov network;

FIGS. 7 and 8 show the decoding principle;

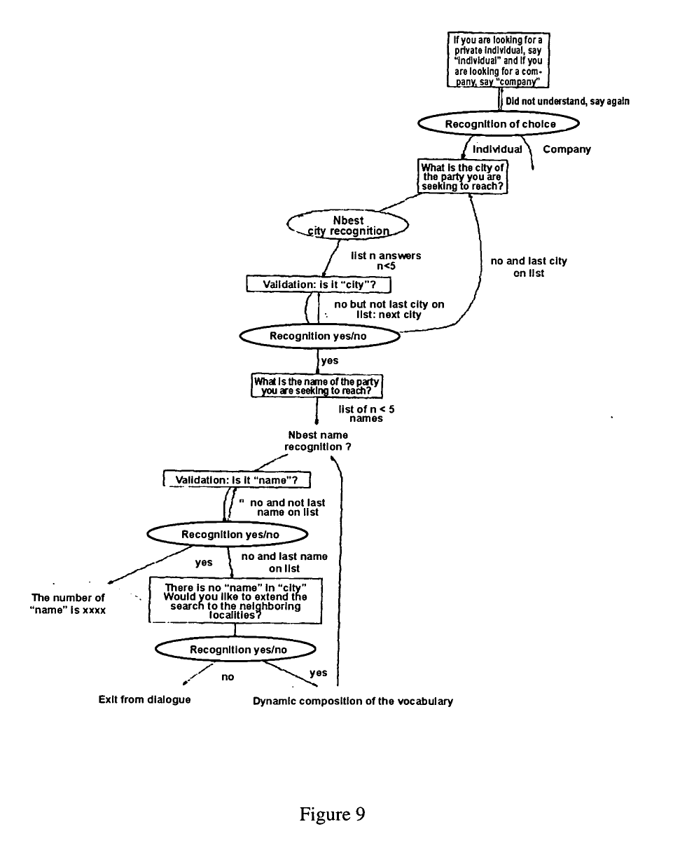

FIG. 9 shows an example of a diagram for implementing the method of the invention;

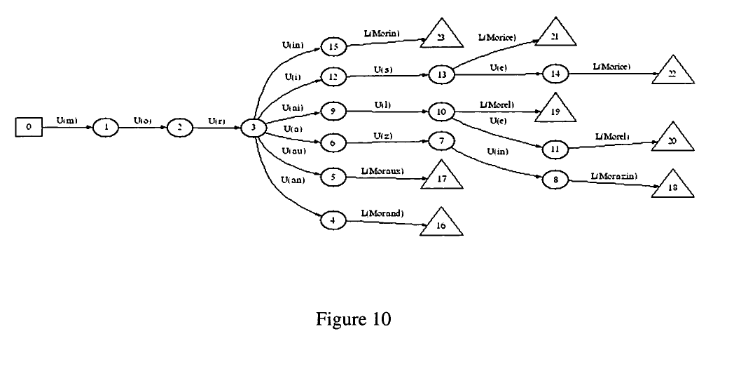

FIG. 10 shows the shape of a tree;

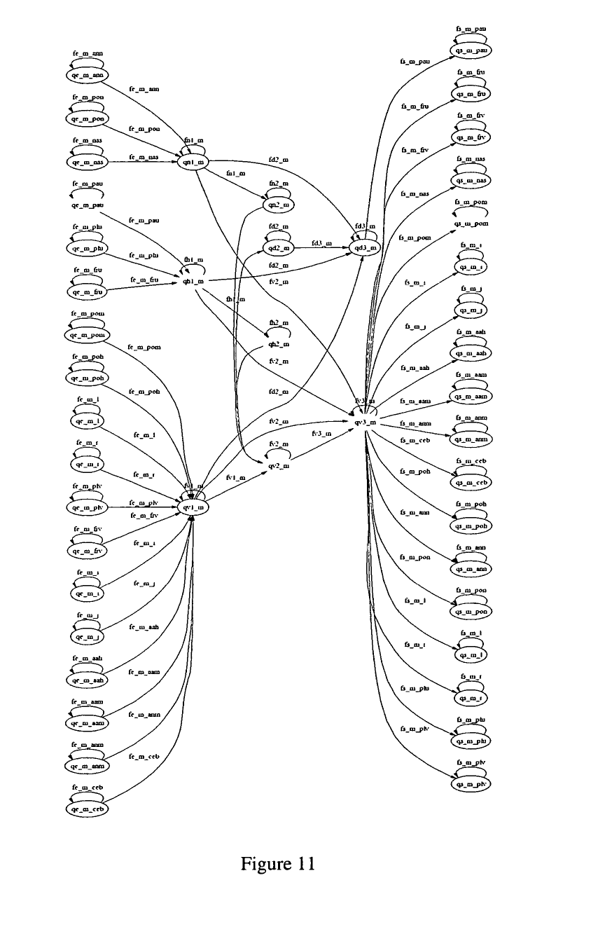

FIG. 11 shows a Markov network representing the phoneme [m];

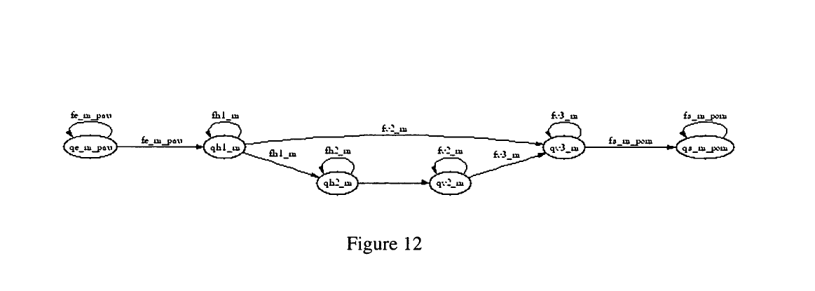

FIG. 12 shows a Markov network extracted from the network of FIG. 11 using context constraints;

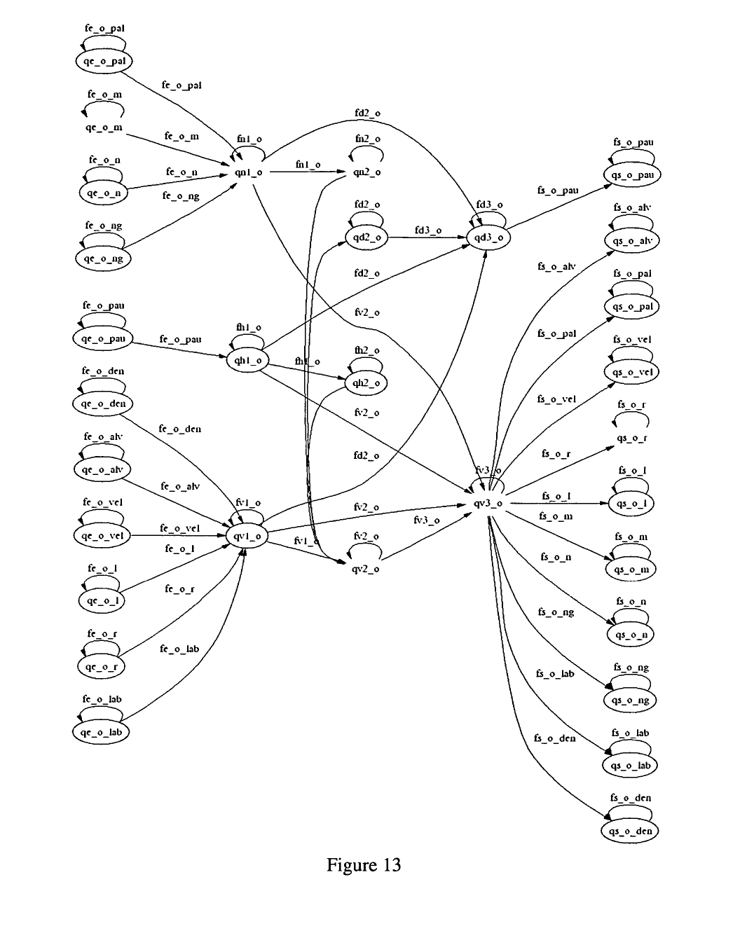

FIGS. 13, 14, 15, 16, 17, 18, 20, and 21 show other Markov networks; and

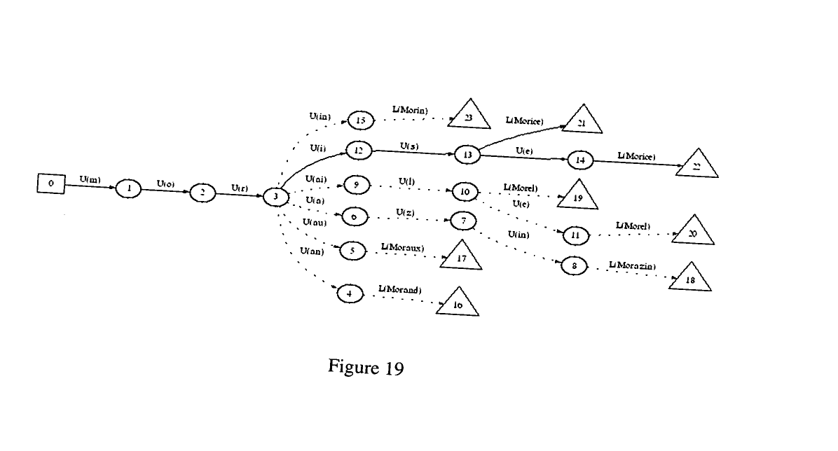

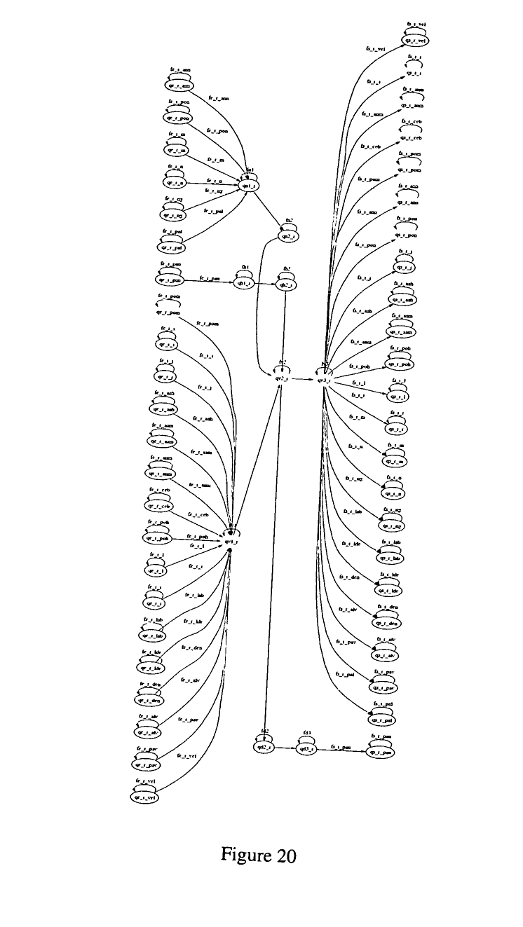

FIG. 19 shows a tree.

In a particular example of use, the invention is particularly adapted to voice recognition on very large lists of words or of names, e.g. for voice directory applications.

The invention is thus described below, in non-limiting manner, for this type of application.

The user accesses the directory through a series of questions and answers, an example of which is given in FIG. 9.

In this sequence of questions, some cause possible answers for a vocabulary constituted by a long list of names: for example “Name Recognition” for a large town or city, if the list of subscribers has been updated. In addition, said list must be enlarged in the event that the dialogue leads to extension to neighboring localities, i.e. the search is to be extended to towns or cities close to the initial town or city of the search.

It is mainly in such events that the present-day technology of the state of the art is unusable, because the Markov network compilation it requires is much too slow.

These diagrams also show the use of Nbest decoding, which makes it possible to list the possible solutions and to request validation by the user.

The lists are built by interrogating a database which, for each town or city, gives the telephone subscribers and the possible phonetizations of the names.

Detailed operation of the invention is described below by using a small list of names, in order to make the developments clear, even though the advantage of the invention lies mainly in its effectiveness for large vocabularies.

Let us take the following names, with their phonetizations:

| | |
|---|---|
| Morand | m . o . r . an |
| Moraux | m . o . r . au |
| Morazin | m . o . r . a . z . in |
| Morel | m . o . r . ai . l . (e+ ( )) |
| Morice | m . o . r . i . s . (e+ ( )) |
| Morin | m . o . r . in |

In the invention proposed, this list is thus not used to produce a conventional network by compilation, as described in the state of the art presented above. Instead, the list is transformed into a deterministic phonetic tree.

For the names given above, the tree takes the shape shown in FIG. 10.

It should be noted that it is extremely quick to create such a diagram, because, on a Hewelett Packard computer of the Pentium 3 type with clock frequency of 1 GHz, it takes, for example, 0.4 seconds to form the tree for a city having a population of 60,000, whereas complete standard compilation of the same list takes about 8 minutes on the same machine, which is incompatible with the time that a person using the service can be made to wait. It is the phase for building the final Markov network that is the longest.

In the present invention, the preceding tree is preferably used in the Viterbi decoding in the following manner (variants are presented below):

The initial state of the diagram is represented by the box numbered 0 and is the state at the beginning of decoding.

This diagram shows that the first phoneme is an [m], with, on the left, a beginning-of-word silence, because it is the first state, and, on the right, a single phoneme [o].

In the set of elementary Markov modes used in the state of the art, the phoneme [m] is represented by the network of FIG. 11.

Then, since on the left of the phoneme [m], there is merely a silence, which corresponds to the input qe_m_pau, and since on the right there is a single phoneme [o], which corresponds to the output qs_m_pom, then only the shaded states of the elementary network are actually accessible and useful.

The network shown in FIG. 12, extracted from the preceding network, is thus composed as a function of the context constraints.

The Viterbi decoding is started, with pruning, on this network. When one of the hypotheses developed in the front reaches the state qs_m_pom, it is then necessary to build the next portion of the network dynamically in order to continue the decoding.

For this purpose, the phonetic arc is used to find that the next phoneme is an [o], lying between the phoneme [m] and the phoneme [r].

The situation is identical:

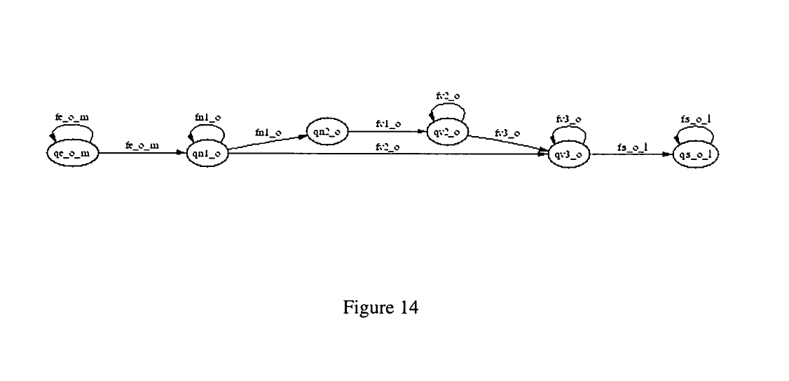

If, for example, the phoneme [o] is represented by the Markov network of the FIG. 13, then the useful portion, represented by the shaded nodes on the drawing, is, due to the contexts, as in FIG. 14.

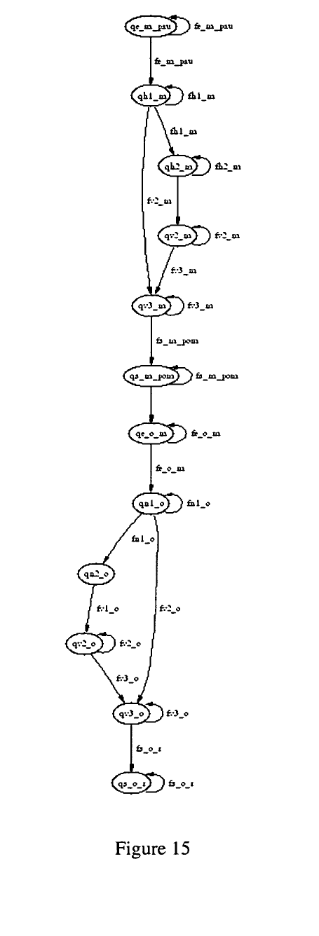

And, at this stage of the decoding, the dynamically constructed network of FIG. 15 is thus obtained.

Once again, when one of the hypotheses of the Viterbi decoding reaches the final state of the network (referenced qs_o_r in this example), the phonetic tree is used to observe that the next phoneme is an [r].

At this stage, the dynamically constructed network is indeed the sub-portion of the complete network as obtained by conventional compilation. The only difference is that it is constructed on request, and not prior to use completely and statically.

In other words, the pruning has not yet had any impact on the development of the network which would actually reduce the developed network portions.

This particular point in our example is addressed below with the decoding being continued in a richer phonetic context:

The [r] is present in a richer context since the phonemes [in], [i], [ai], [a], [au], [an] are to be found on its right in the tree.

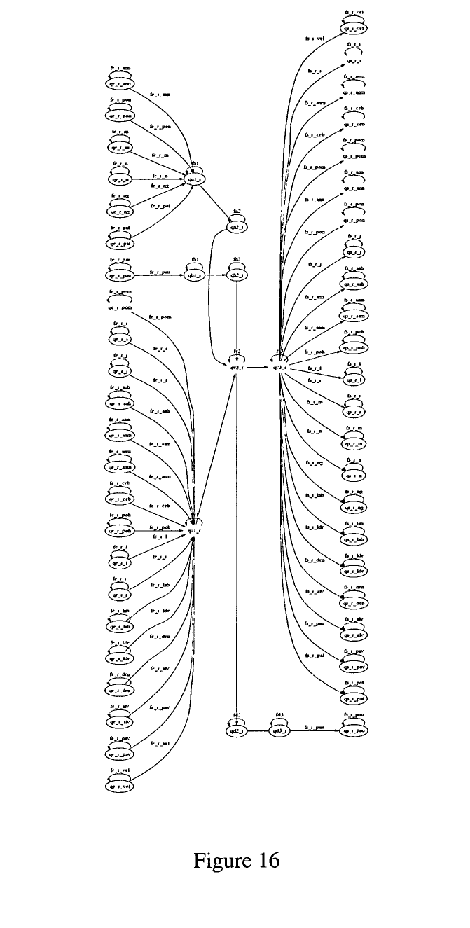

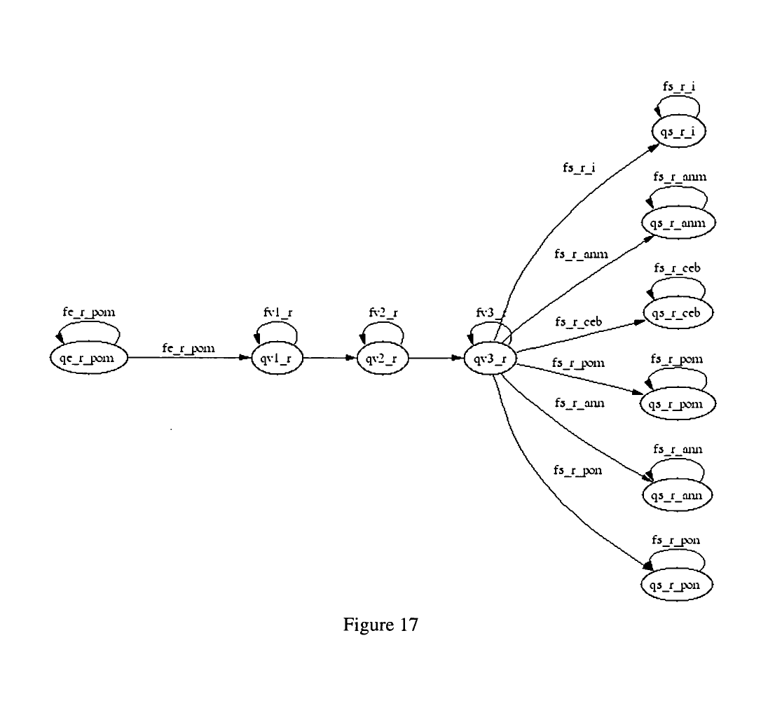

If the [r] is represented by the network of FIG. 16, then the useful portion of this context is as shown in FIG. 17.

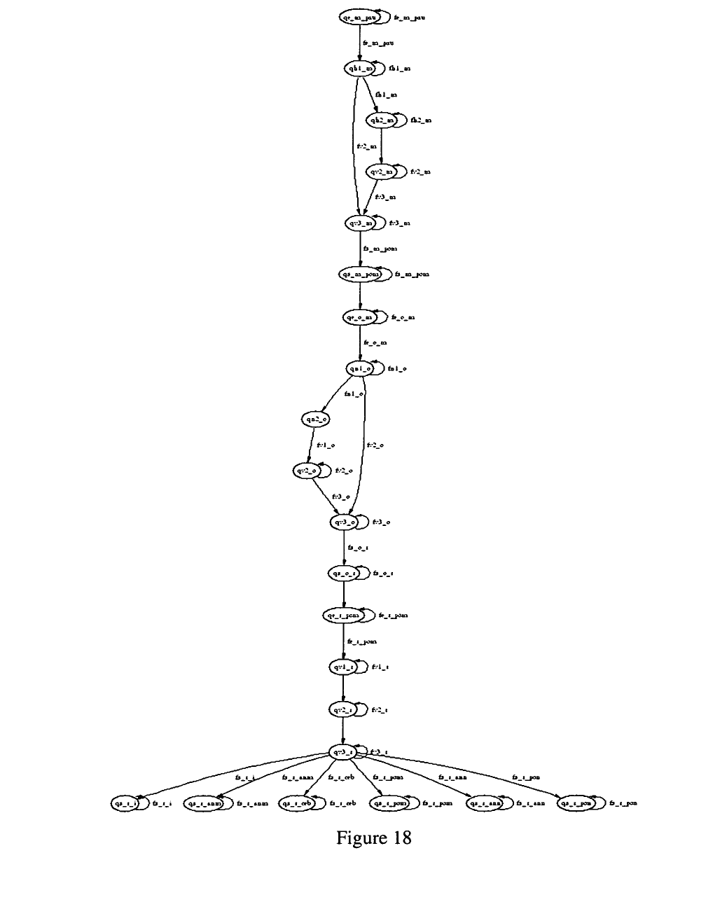

And, finally, at this stage, the dynamically constructed active network shown in FIG. 18 is reached.

Let us assume that, during the Viterbi decoding based on this network, one of the hypotheses leads to the output state qs_r_i (because the user actually says “Morice”) with a score that is so high that the other hypotheses, arriving in the other output states, are removed from the front.

Then, during the next dynamic development, only the branch of the tree that is associated with this hypothesis is developed, the others being abandoned. Everything is as if the decoding continued without the branches of the tree that are shown in dashed lines in FIG. 19.

Thus, this time, due to the pruning, the network that is developed dynamically using the principle of the invention is no longer the image of the complete network obtained by state-of-the-art compilation: it is a much smaller network.

The example developed herein is simple for reasons of clarity, but, in real applications, the portion of the network that is actually developed is very small compared with the conventional network obtained by compilation.

It can thus be said that, in the state of the art, the Markov network corresponding to the vocabulary of the application is constructed once and or all, and that, for each decoding operation, only a small portion of that network is actually used because of the pruning implemented during the decoding.

Using the principle of the invention, the complete network is never built, but rather that portion of the network which is actually necessary for a given recognition is constructed dynamically during the decoding.

In the implementation presented above, that portion of the hidden Markov network of the application which is necessary for decoding is constructed dynamically, step-by-step, by cutting up the elementary Markov networks in order to extract the useful sub-portion therefrom, depending on the contexts of appearance of the phonemes in the tree of the application.

In this process, the phonetic tree of the application plays a central role for determining said contexts, and for making it possible to perform Nbest decoding effectively and simply, due to the very fact that it has a tree structure rather than a graph structure.

Other implementations of the proposed invention exist that keep the central role for the tree for the reasons described.

One of these alternatives is described below, without excluding other variants.

Let us assume that, for a given language, we have 40 elementary Markov networks representing the phonemes used in that language for phonetizing the words. As in the examples given, these networks have input states and output states for representing the phonetic contexts, in compliance with strict rules: for example a state qs_x_i can be connected only to a state qe_y_i, where x and y are any two elementary networks.

It is then possible to construct an overall network in which the 40 sub-networks are put in parallel, and, in addition, all of the outputs of each network are connected by empty transitions to all of the inputs of all of the networks that are compatible with it, depending on the phonetic contexts (i.e. we have a Markov network corresponding to all of the possible strings of phonemes).

It is then possible, instead of developing (as above) the useful portion of the network, to use the Viterbi algorithm in which the states handled are pairs, each made up of a state of the complete network formed as described above and of a node of the phonetic tree.

When a hypothesis leads to one of the output states of a butterfly, it is then verified in the phonetic tree that there are indeed branches that are compatible with the phonetic context associated with said state. Otherwise, the development of that hypothesis is abandoned as if it were removed by standard pruning.

This method is functionally equivalent to the method proposed above, but it is more costly in computation time because hypotheses are developed even if it subsequently transpires that they lead to phonetic contexts which are not present in the tree of the application and thus that they are removed anyway.

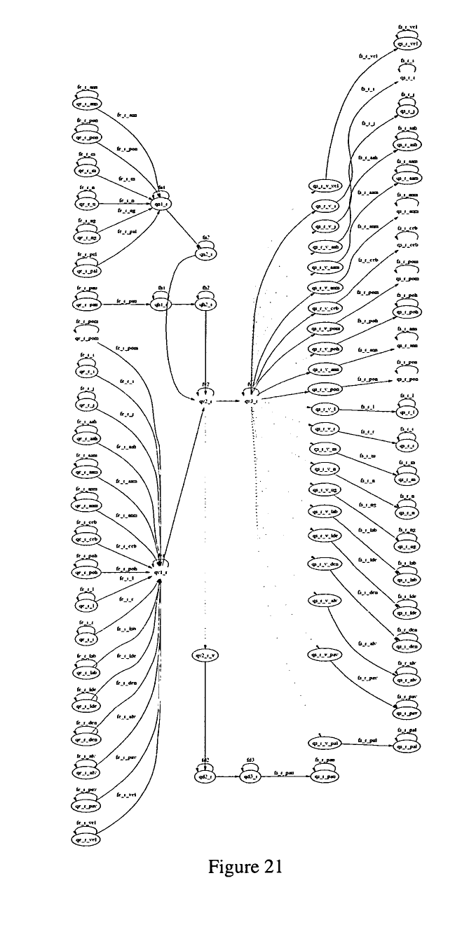

In order to illustrate this point, it is possible to use, once again, the example of the phoneme [r] that is used in the preceding example. Because of the particular structure of the tree of our example, only the shaded states of the complete network, and the transitions between those states, are finally useful. To this end, reference is made to FIG. 20.

In accordance with the description of this variant, the other transitions towards all of the non-shaded outputs would also be developed, but would then be abandoned when the output state was reached, because none of the contexts associated with said states is present in the tree of this simple application.

It is possible to remedy the problem of this extra work by adding new empty transitions in each of the elementary networks used, which behave like gates, i.e. they can be opened or closed.

In the example of the network associated with the above phoneme [r], the network of FIG. 21 would, for example, be obtained.

In this network, the transitions in dashed lines show transitions of the “open” gate type due to the context of appearance of the [r], which means that not all of the output states can be reached.

For the activated output states, shaded in the diagram, the associated gates are shown in uninterrupted lines.

In the development front used by the Viterbi decoding algorithm with pruning, it is necessary not only, as described above, to keep a reference to the state of the network associated with the hypothesis that said element of the front represents, but also to keep in suitable variables the states of the gates (open or closed), while taking account of the right contexts of appearance of the phoneme in the tree.

For example, it is possible that, in the same front, two different references to the same phoneme and thus to the same network are present, but in different phonetic contexts and thus with different positions of the gates.

This variant is thus functionally equivalent to the standard implementation presented. Nevertheless, in order for it to be as effective, it is necessary to add empty transitions of the gate type and to control them for each element of the front during the decoding as a function of the contexts encountered on the right of each phoneme in the phonetic tree.

It has been explained above that the phonetic tree is central for the proposed invention, mainly so as to enable Nbest decoding to be performed without any extra cost.

Naturally, it is possible to store said tree more compactly, e.g. by storing a graph equivalent to the tree whose right portions common to a plurality of branches are factored.

Such a compact form is then used as a representation of the tree itself in the standard manner described above.

The invention is described above by way of example. It is to be understood that the person skilled in the art can implement variants of the invention without going beyond the ambit of the patent.

1. A voice recognition method comprising:
representing a vocabulary translated into a Markov network;
decoding by means of a Viterbi algorithm;
pruning explored solutions, and
wherein said vocabulary is described in a tree made up of arcs and of nodes, between which transcriptions are defined that describe phonetic units used by a language model, and
wherein the Markov network is constructed dynamically at least in part by means of Markov sub-units.

2. A voice recognition method according to claim 1, wherein words of the vocabulary that are different but that present identical phonetic segments at each respective beginning of the words share, for the branches of the tree for the identical phonetic segments.

3. A voice recognition method according to claim 1, wherein said phonetic units include phonemes.

4. A voice recognition method according to claim 1, wherein said phonetic units include context phonemes.

5. A voice recognition system comprising:
at least one memory; and
computation means,
wherein the computation means includes,
means for representing a vocabulary translated into a Markov network, and
means for pruning explored solutions.

6. A voice recognition method according to claim 2, wherein said phonetic units include phonemes.

7. A voice recognition method according to claim 2, wherein said phonetic units include context phonemes.
